(19) United States
(12) Patent Application Publication
(10) Pub. No.: US 2026/0352802 A1
(43) Pub. Date: Nov. 5, 2026

(54) TEMPORAL PREDICTION FOR PARTITIONING PARAMETERS

(71) Applicant: InterDigital CE Patent Holdings, SAS, Paris (FR)

(72) Inventors: Ya Chen, Rennes (FR); Fabrice Le Léannec, Betton (FR); Karam Naser, Mouazé (FR); Miloš Radosavljevic, Rennes (FR)

(73) Assignee: InterDigital CE Patent Holdings, SAS, Paris (FR)

(21) Appl. No.: 19/486,016

(22) PCT Filed: Jun. 7, 2024
(86) PCT No.: PCT/EP2024/065700

§ 371 Date: Nov. 19, 2025

(30) Foreign Application Priority Data
Jun. 30, 2023 (EP) 23306114.2

(51) Int. Cl. H04N 19/105; H04N 19/137; H04N 19/176; H04N 19/177

(52) U.S. Cl. CPC H04N 19/105; H04N 19/137; H04N 19/176; H04N 19/177

(57) ABSTRACT

Video coding may be performed using enhanced temporal prediction for partitioning parameters. Coding information (e.g., motion vector difference (MVD) of the current coding unit (CU)) and/or more temporal areas from previously coded frames may be used. For example a device for video decoding and/or encoding may obtain a plurality of collocated pictures of a current picture. The current picture may include a current video block. The device may identify, for the current video block, a plurality of collocated coding blocks in the plurality of collocated pictures. The device may predict a partition parameter associated with the current video block based on partition information associated with the plurality of collocated coding blocks. The device may decode and/or encode the current video block based on the predicted partition parameter.

### CROSS-REFERENCE TO RELATED APPLICATIONS

This application claims the benefit of European Provisional Patent Application No. 23306114.2, filed Jun. 30, 2023, the contents of which are hereby incorporated by reference herein.

### BACKGROUND

Video coding systems may be used to compress digital video signals, e.g., to reduce the storage and/or transmission bandwidth needed for such signals. Video coding systems may include, for example, block-based, wavelet-based, and/or object-based systems.

### SUMMARY

Systems, methods, and instrumentalities are disclosed for performing video coding using temporal prediction for partitioning parameters. The temporal prediction of partitioning parameters may be enhanced by utilizing: the coding information (e.g., motion vector difference (MVD) of the current coding unit (CU)) and/or more temporal areas from several previous coded frames. For example, multiple (e.g., two) collocated reference pictures may be derived and/or used to perform the bi-predictive temporal prediction of the partitioning parameters for a (e.g., each) B slice. The temporal prediction may be utilized to derive other partitioning parameters, such as one or more of the following: the allowance and the direction of intra sub-partitions (ISP) split; the allowance, the direction, and/or the position of subblock transform (SBT) split; and/or the allowances and/or the partitioning modes of geometric partition mode (GPM) Intra/spatial GPM (SGPM)/intra block copy with geometry partitioning (IBC-GPM).

A coding device (e.g., decoder) may obtain a current coding block. The decoder may determine whether to temporally predict a partition parameter associated with the current coding block, for example, based on coding information associated with the current coding block. The coding information associated with the current coding block may comprise at least one of a quantization parameter, a block size, or a color component of the current coding block. The coding information associated with the current coding block may comprise an MVD. The decoder may decode the current coding block based on the determining.

The decoder may determine whether to temporally predict a partition parameter associated with the current coding block, for example, based on the MVD. For example, based on the MVD being zero, the decoder may determine to temporally predict the partition parameter(s) associated with the current coding block. For example, based on the MVD being less than a value, the decoder may determine to temporally predict the partition parameter(s) associated with the current coding block. For example, the decoder may (e.g., determine to) refrain from temporally predicting the partition parameter associated with the current coding block, for example, based on the MVD being above a value.

Upon determining to temporally predict the partition parameters, the decoder may obtain a collocated picture and may identify, in the collocated picture, a collocated coding block of the current block. The decoder may determine the partition parameter associated with the current coding block, for example, based on partition information associated with the collocated coding block.

A coding device (e.g., an encoder) may obtain a current coding block. The encoder may determine whether to temporally predict a partition parameter associated with the current coding block, for example, based on coding information associated with the current coding block. The coding information associated with the current coding block may comprise at least one of a quantization parameter, a block size, or a color component of the current coding block. The coding information associated with the current coding block may comprise an MVD. The encoder may encode the current coding block based on the determining.

For example, based on the MVD being zero, the encoder may determine to temporally predict the partition parameter(s) associated with the current coding block. For example, based on the MVD being less than a value, the encoder may determine to temporally predict the partition parameter(s) associated with the current coding block. For example, based on the MVD being above a value, the encoder may (e.g., determine to) refrain from temporally predicting the partition parameter associated with the current coding block.

Upon determining to temporally predict the partition parameters, the encoder may obtain a collocated picture and may identify, in the collocated picture, a collocated coding block of the current block. The encoder may determine the partition parameter associated with the current coding block, for example, based on partition information associated with the collocated coding block.

For example, a device video encoding and/or decoding may include a processor. The device may obtain a plurality of collocated pictures of a current picture. The current picture may include a current video block. The device may identify, for the current video block, a plurality of collocated coding blocks in the plurality of collocated pictures. The device may predict a partition parameter associated with the current video block based on partition information associated with the plurality of collocated coding blocks. The device may encode and/or decode the current video block based on the predicted partition parameter.

The device may include one or more features as described herein. For example, the plurality of collocated pictures may be obtained based on the current picture being a bi-predicted picture. For example, the plurality of collocated pictures may include at least one reference picture of the current picture. For example, the partition information may include a temporal depth associated with a first collocated coding block and/or a temporal depth associated with a second collocated coding block in the plurality of collocated coding blocks. For example, the device may determine a difference between the temporal depth associated with the first collocated coding block and the temporal depth associated with the second collocated coding block. The device may compare the difference between the temporal depth associated with the first collocated coding block and the temporal depth associated with the second collocated coding block to a threshold. The device may, based on the comparison, determine whether to refrain from predicting the partition parameter, wherein prediction of the partition parameter associated with the current video block is performed based on the difference being below the threshold.

For example, the device may obtain a motion vector difference for the current video block. For example, the device may compare the motion vector difference to a threshold. For example, the device may, based on a comparison, determine whether to refrain from predicting the partition parameter, wherein prediction of the partition parameter associated with the current video block is performed based on the motion vector difference being below the threshold. For example, the device may obtain a motion vector difference for the current video block, wherein prediction of the partition parameter associated with the current video block may be performed based on the partition information associated with the plurality of collocated coding blocks and/or the motion vector difference for the current video block. For example, prediction of the partition parameter associated with the current video block may be performed further based on at least one of a block partition, an intra sub-partition, a subblock transform, or a geometric partition mode. For example, prediction of the partition parameter associated with the current video block may be performed based on the partition information associated with the plurality of collocated coding blocks and/or at least one of a quantization parameter, a block size, or a color component of the current video block.

In an example, a method for video encoding and/or decoding may include obtaining a plurality of collocated pictures of a current picture, the current picture including a current video block. The method may include identifying, for the current video block, a plurality of collocated coding blocks in the plurality of collocated pictures. The method may include predicting a partition parameter associated with the current video block based on partition information associated with the plurality of collocated coding blocks. The method may include encoding and/or decoding the current video block based on the predicted partition parameter.

A method for video encoding and/or decoding may include one or more features as described herein. For example, the plurality of collocated pictures may be obtained based on the current picture being a bi-predicted picture. For example, the plurality of collocated pictures may include at least one reference picture of the current picture. For example, the partition information may include a temporal depth associated with a first collocated coding block and/or a temporal depth associated with a second collocated coding block in the plurality of collocated coding blocks. For example, the method may include determining a difference between the temporal depth associated with the first collocated coding block and the temporal depth associated with the second collocated coding block. For example, the method may include comparing the difference between the temporal depth associated with the first collocated coding block and the temporal depth associated with the second collocated coding block to a threshold. For example, the method may include, based on the comparison, determining whether to refrain from predicting the partition parameter, wherein prediction of the partition parameter associated with the current video block may be performed based on the difference being below the threshold. For example, the method may include obtaining a motion vector difference for the current video block. The method may include comparing the motion vector difference to a threshold. The method may include, based on the comparison, determining whether to refrain from predicting the partition parameter, wherein prediction of the partition parameter associated with the current video block may be performed based on the motion vector difference being below the threshold.

For example, a method may include obtaining a motion vector difference for the current video block. The prediction of the partition parameter associated with the current video block may be performed based on the partition information associated with the plurality of collocated coding blocks and/or the motion vector difference for the current video block. The prediction of the partition parameter associated with the current video block may be performed further based on at least one of a block partition, an intra sub-partition, a subblock transform, or a geometric partition mode. For example, prediction of the partition parameter associated with the current video block may be performed based on the partition information associated with the plurality of collocated coding blocks and/or at least one of a quantization parameter, a block size, or a color component of the current video block.

In examples, a computer program product which is stored on a non-transitory computer readable medium may include program code instructions for implementing one or more steps and/or features according to a method as described herein. In examples, video data may include information representative of the current video block encoded in accordance with any one of the steps and/or features as described herein.

Systems, methods, and instrumentalities described herein may involve a decoder. In some examples, the systems, methods, and instrumentalities described herein may involve an encoder. In some examples, the systems, methods, and instrumentalities described herein may involve a signal (e.g., from an encoder and/or received by a decoder). A computer-readable medium may include instructions for causing one or more processors to perform methods described herein. A computer program product may include instructions which, when the program is executed by one or more processors, may cause the one or more processors to carry out the methods described herein.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates an example video encoder.

FIG. 3 illustrates an example video decoder.

FIG. 4 illustrates an example of a system in which various aspects and examples may be implemented.

FIG. 5 illustrates an example of splitting types in a multi-type tree structure.

FIG. 6 illustrates an example of a signaling mechanism of partition splitting information in a QT with nested MTT coding tree structure.

FIG. 7 illustrates an example of a CTU divided into multiple CUs with a quadtree and nested multi-type tree coding block structure.

FIG. 8 illustrates examples of intra sub-partitions.

FIG. 9 illustrates an example of SBT type and position information that may be signaled in a bitstream.

FIG. 10 illustrates an example of splitting a CU in geometric partition mode.

FIG. 11 illustrates an example of deriving a blending weight for each position of a CU.

FIGS. 12A-12C illustrate examples of parallel mode, perpendicular mode, and planar mode intra prediction mode (IPM) candidates that may be added to GPM.

FIGS. 13A and 13B illustrate examples of a partition mode and intra prediction modes for spatial geometry partition mode (SGPM).

FIG. 14 illustrates an example of partition modes in SGPM.

### DETAILED DESCRIPTION

A more detailed understanding may be had from the following description, given by way of example in conjunction with the accompanying drawings.

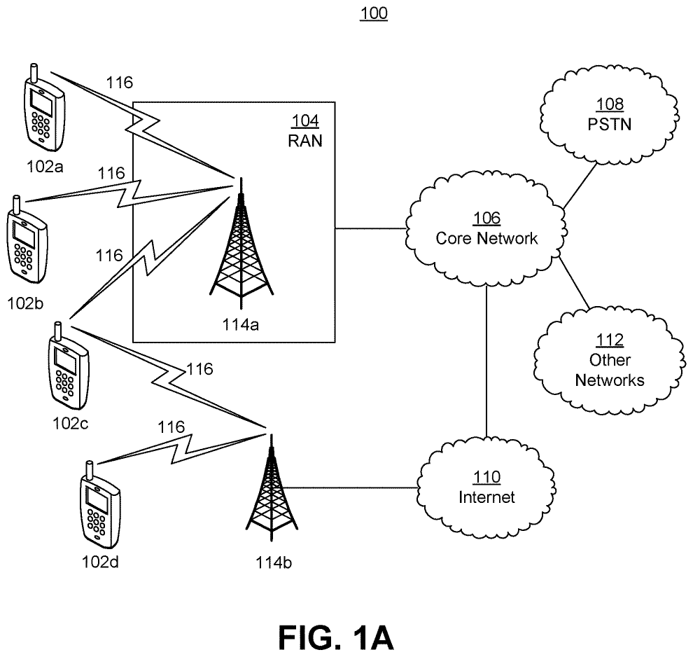

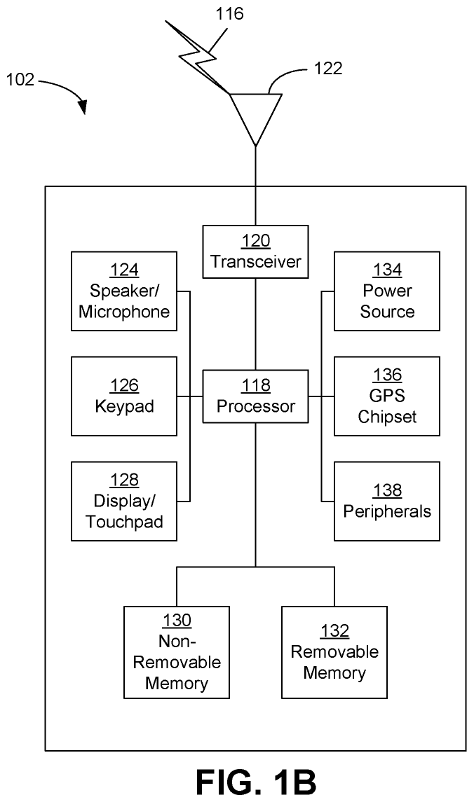

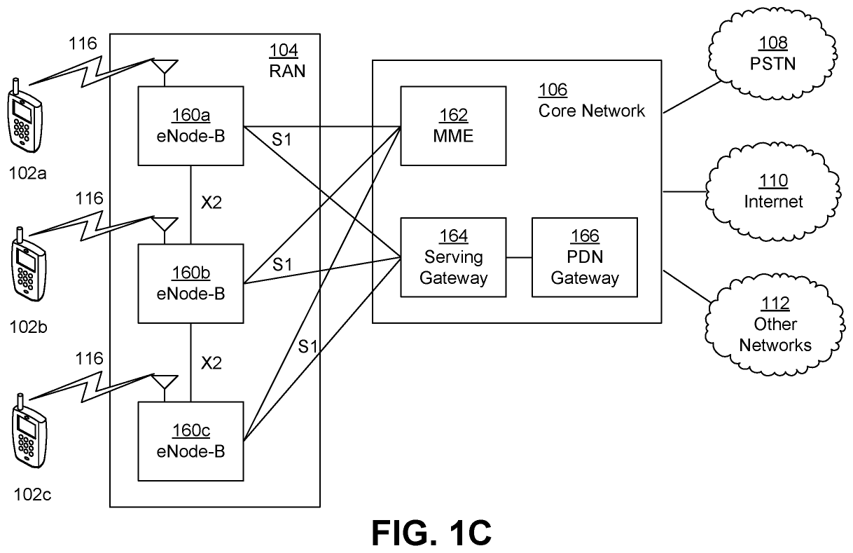

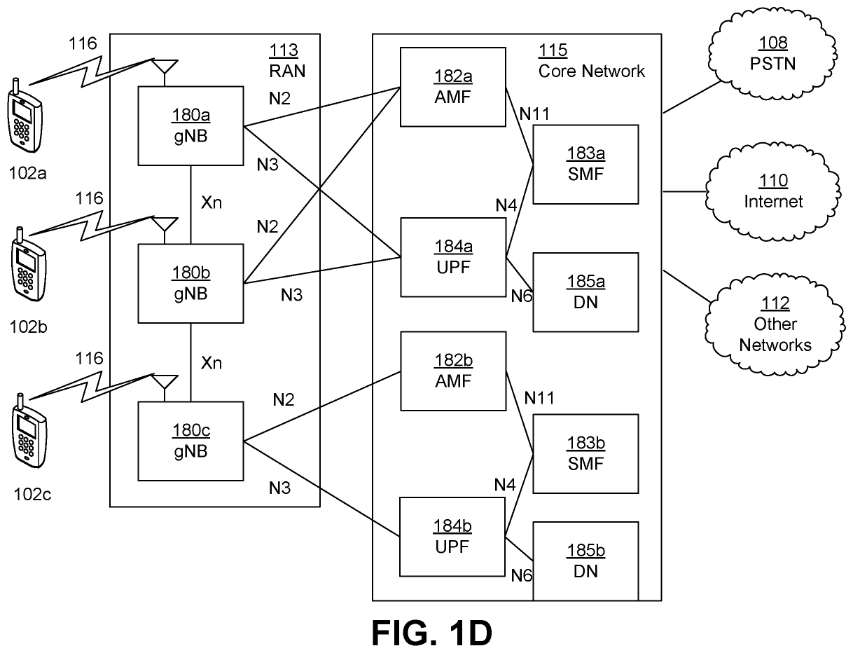

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 182a, 182b may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

This application describes a variety of aspects, including tools, features, examples, models, approaches, etc. Many of these aspects are described with specificity and, at least to show the individual characteristics, are often described in a manner that may sound limiting. However, this is for purposes of clarity in description, and does not limit the application or scope of those aspects. Indeed, all of the different aspects may be combined and interchanged to provide further aspects. Moreover, the aspects may be combined and interchanged with aspects described in earlier filings as well.

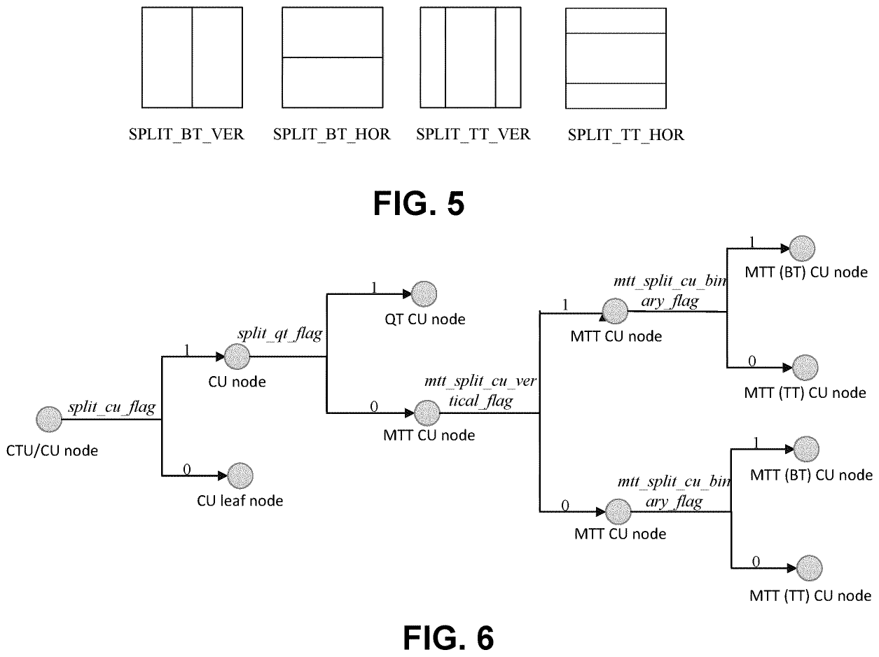

The aspects described and contemplated in this application may be implemented in many different forms. FIGS. 5-14 described herein may provide some examples, but other examples are contemplated. The discussion of FIGS. 5-14 does not limit the breadth of the implementations. At least one of the aspects generally relates to video encoding and decoding, and at least one other aspect generally relates to transmitting a bitstream generated or encoded. These and other aspects may be implemented as a method, an apparatus, a computer readable storage medium having stored thereon instructions for encoding or decoding video data according to any of the methods described, and/or a computer readable storage medium having stored thereon a bitstream generated according to any of the methods described.

In the present application, the terms “reconstructed” and “decoded” may be used interchangeably, the terms “pixel” and “sample” may be used interchangeably, the terms “image,” “picture” and “frame” may be used interchangeably.

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various examples to modify an element, component, step, operation, etc., such as, for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding.

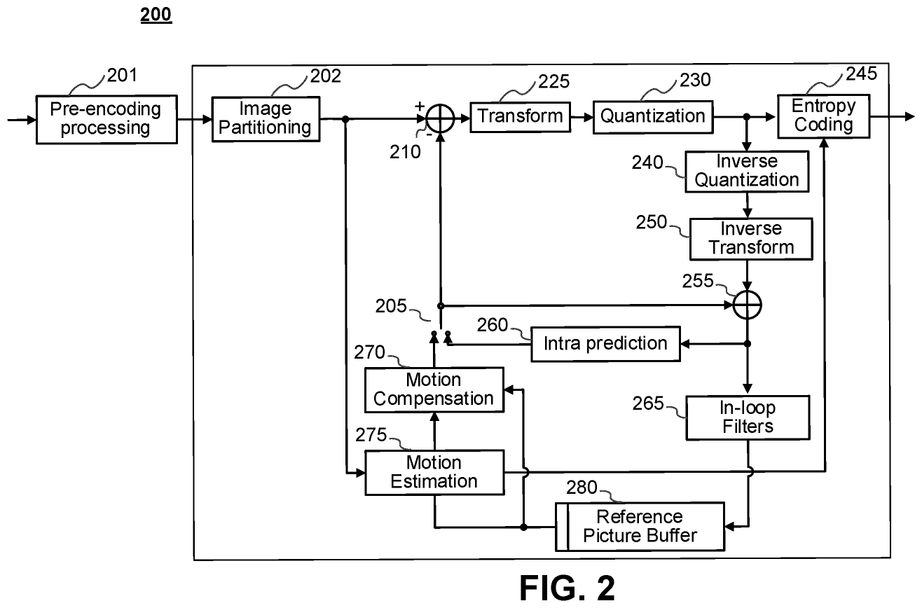

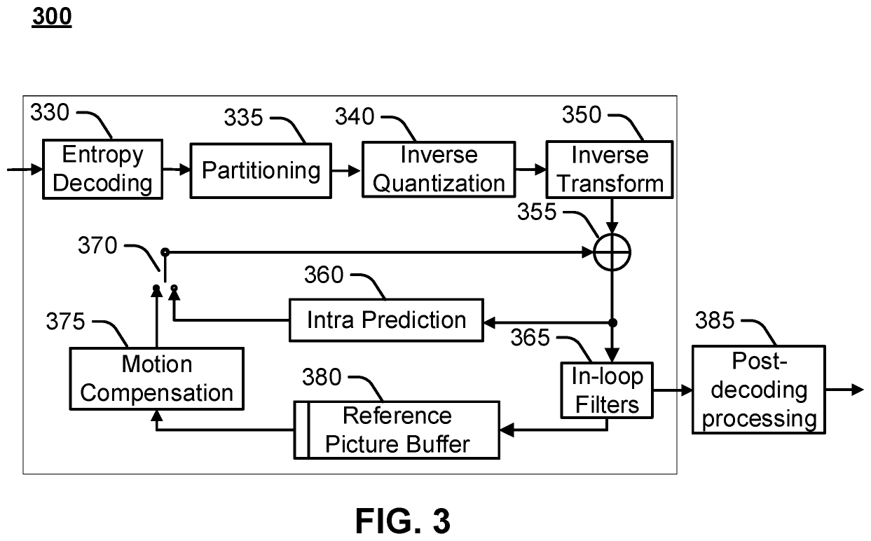

Various methods and other aspects described in this application may be used to modify modules, for example, decoding modules, of a video encoder 200 and decoder 300 as shown in FIG. 2 and FIG. 3. Moreover, the subject matter disclosed herein may be applied, for example, to any type, format or version of video coding, whether described in a standard or a recommendation, whether pre-existing or future-developed, and extensions of any such standards and recommendations. Unless indicated otherwise, or technically precluded, the aspects described in this application may be used individually or in combination.

Various numeric values are used in examples described the present application, such as syntax values (e.g., flag values), CU sizes, block sizes, transform sizes, dimensions, minimums, maximums, averages, thresholds, ratios, splits, fractions, dividers, multipliers, constants, tree depths, number of sub-partitions, sub-partition sizes, weights, table entries, number of modes, mode values, number of references, number of candidates, number of pixels, etc. These and other specific values are for purposes of describing examples and the aspects described are not limited to these specific values.

FIG. 2 is a diagram showing an example video encoder. FIG. 2 shows an example of a block-based hybrid video encoder. Variations of example encoder 200 are contemplated, but the encoder 200 is described below for purposes of clarity without describing all expected variations.

Before being encoded, the video sequence may go through pre-encoding processing (201), for example, applying a color transform to the input color picture (e.g., conversion from RGB 4:4:4 to YCbCr 4:2:0), or performing a remapping of the input picture components in order to get a signal distribution more resilient to compression (for instance using a histogram equalization of one of the color components). Metadata may be associated with the pre-processing, and attached to the bitstream.

In the encoder 200, a picture is encoded by the encoder elements as described below. The picture to be encoded is partitioned (202) and processed in units of, for example, coding units (CUs). Each unit is encoded using, for example, either an intra or inter mode. When a unit is encoded in an intra mode, it performs intra prediction (260). In an inter mode, motion estimation (275) and compensation (270) are performed. The encoder decides (205) which one of the intra mode or inter mode to use for encoding the unit, and indicates the intra/inter decision by, for example, a prediction mode flag. Prediction residuals are calculated, for example, by subtracting (210) the predicted block from the original image block.

The prediction residuals are then transformed (225) and quantized (230). The quantized transform coefficients, as well as motion vectors and other syntax elements, such as picture partitioning information, are entropy coded (245) to output a bitstream. The encoder can skip the transform and apply quantization directly to the non-transformed residual signal. The encoder can bypass both transform and quantization, i.e., the residual is coded directly without the application of the transform or quantization processes.

The encoder decodes an encoded block to provide a reference for further predictions. The quantized transform coefficients are de-quantized (240) and inverse transformed (250) to decode prediction residuals. Combining (255) the decoded prediction residuals and the predicted block, an image block is reconstructed. In-loop filters (265) are applied to the reconstructed picture to perform, for example, deblocking/SAO (Sample Adaptive Offset)/ALF (Adaptive Loop Filtering) filtering to reduce encoding artifacts. The filtered image is stored at a reference picture buffer (280).

FIG. 3 is a diagram showing an example of a video decoder. In example decoder 300, a bitstream is decoded by the decoder elements as described below. Video decoder 300 generally performs a decoding pass reciprocal to the encoding pass as described in FIG. 2. The encoder 200 also generally performs video decoding as part of encoding video data.

In particular, the input of the decoder includes a video bitstream, which may be generated by video encoder 200. The bitstream is first entropy decoded (330) to obtain transform coefficients, prediction modes, motion vectors, and other coded information. The picture partition information indicates how the picture is partitioned. The decoder may therefore divide (335) the picture according to the decoded picture partitioning information. The transform coefficients are de-quantized (340) and inverse transformed (350) to decode the prediction residuals. Combining (355) the decoded prediction residuals and the predicted block, an image block is reconstructed. The predicted block may be obtained (370) from intra prediction (360) or motion-compensated prediction (i.e., inter prediction) (375). In-loop filters (365) are applied to the reconstructed image. The filtered image is stored at a reference picture buffer (380). In some examples (e.g., for a given picture) the contents of the reference picture buffer 380 on the decoder 300 side may be identical to the contents of the reference picture buffer 280 on the encoder 200 side (e.g., for the same picture).

The decoded picture can further go through post-decoding processing (385), for example, an inverse color transform (e.g. conversion from YCbCr 4:2:0 to RGB 4:4:4) or an inverse remapping performing the inverse of the remapping process performed in the pre-encoding processing (201). The post-decoding processing can use metadata derived in the pre-encoding processing and signaled in the bitstream. In an example, the decoded images (e.g., after application of the in-loop filters (365) and/or after post-decoding processing (385), if post-decoding processing is used) may be sent to a display device for rendering to a user.

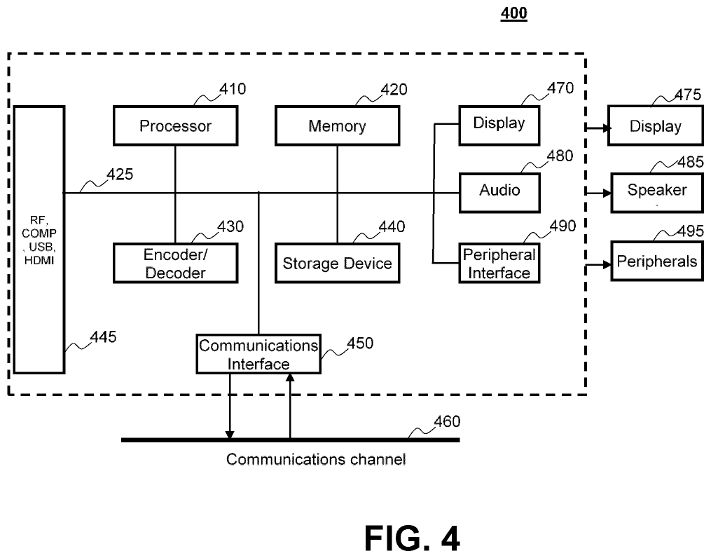

FIG. 4 is a diagram showing an example of a system in which various aspects and examples described herein may be implemented. System 400 may be embodied as a device including the various components described below and is configured to perform one or more of the aspects described in this document. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 400, singly or in combination, may be embodied in a single integrated circuit (IC), multiple ICs, and/or discrete components. For example, in at least one example, the processing and encoder/decoder elements of system 400 are distributed across multiple ICs and/or discrete components. In various examples, the system 400 is communicatively coupled to one or more other systems, or other electronic devices, via, for example, a communications bus or through dedicated input and/or output ports. In various examples, the system 400 is configured to implement one or more of the aspects described in this document.

The system 400 includes at least one processor 410 configured to execute instructions loaded therein for implementing, for example, the various aspects described in this document. Processor 410 can include embedded memory, input output interface, and various other circuitries as known in the art. The system 400 includes at least one memory 420 (e.g., a volatile memory device, and/or a non-volatile memory device). System 400 includes a storage device 440, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive. The storage device 440 can include an internal storage device, an attached storage device (including detachable and non-detachable storage devices), and/or a network accessible storage device, as non-limiting examples.

System 400 includes an encoder/decoder module 430 configured, for example, to process data to provide an encoded video or decoded video, and the encoder/decoder module 430 can include its own processor and memory. The encoder/decoder module 430 represents module(s) that may be included in a device to perform the encoding and/or decoding functions. As is known, a device can include one or both of the encoding and decoding modules. Additionally, encoder/decoder module 430 may be implemented as a separate element of system 400 or may be incorporated within processor 410 as a combination of hardware and software as known to those skilled in the art.

Program code to be loaded onto processor 410 or encoder/decoder 430 to perform the various aspects described in this document may be stored in storage device 440 and subsequently loaded onto memory 420 for execution by processor 410. In accordance with various examples, one or more of processor 410, memory 420, storage device 440, and encoder/decoder module 430 can store one or more of various items during the performance of the processes described in this document. Such stored items can include, but are not limited to, the input video, the decoded video or portions of the decoded video, the bitstream, matrices, variables, and intermediate or final results from the processing of equations, formulas, operations, and operational logic.

In some examples, memory inside of the processor 410 and/or the encoder/decoder module 430 is used to store instructions and to provide working memory for processing that is needed during encoding or decoding. In other examples, however, a memory external to the processing device (for example, the processing device may be either the processor 410 or the encoder/decoder module 430) is used for one or more of these functions. The external memory may be the memory 420 and/or the storage device 440, for example, a dynamic volatile memory and/or a non-volatile flash memory. In several examples, an external non-volatile flash memory is used to store the operating system of, for example, a television. In at least one example, a fast external dynamic volatile memory such as a RAM is used as working memory for video encoding and decoding operations.

The input to the elements of system 400 may be provided through various input devices as indicated in block 445. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 4, include composite video.

In various examples, the input devices of block 445 have associated respective input processing elements as known in the art. For example, the RF portion may be associated with elements suitable for (i) selecting a desired frequency (also referred to as selecting a signal, or band-limiting a signal to a band of frequencies), (ii) downconverting the selected signal, (iii) band-limiting again to a narrower band of frequencies to select (for example) a signal frequency band which may be referred to as a channel in certain examples, (iv) demodulating the downconverted and band-limited signal, (v) performing error correction, and/or (vi) demultiplexing to select the desired stream of data packets. The RF portion of various examples includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, downconverting the received signal to a lower frequency (for example, an intermediate frequency or a near-baseband frequency) or to baseband. In one set-top box example, the RF portion and its associated input processing element receives an RF signal transmitted over a wired (for example, cable) medium, and performs frequency selection by filtering, downconverting, and filtering again to a desired frequency band. Various examples rearrange the order of the above-described (and other) elements, remove some of these elements, and/or add other elements performing similar or different functions. Adding elements can include inserting elements in between existing elements, such as, for example, inserting amplifiers and an analog-to-digital converter. In various examples, the RF portion includes an antenna.

The USB and/or HDMI terminals can include respective interface processors for connecting system 400 to other electronic devices across USB and/or HDMI connections. It is to be understood that various aspects of input processing, for example, Reed-Solomon error correction, may be implemented, for example, within a separate input processing IC or within processor 410 as necessary. Similarly, aspects of USB or HDMI interface processing may be implemented within separate interface ICs or within processor 410 as necessary. The demodulated, error corrected, and demultiplexed stream is provided to various processing elements, including, for example, processor 410, and encoder/decoder 430 operating in combination with the memory and storage elements to process the datastream as necessary for presentation on an output device.

Various elements of system 400 may be provided within an integrated housing, Within the integrated housing, the various elements may be interconnected and transmit data therebetween using suitable connection arrangement 425, for example, an internal bus as known in the art, including the Inter-IC (12C) bus, wiring, and printed circuit boards.

The system 400 includes communication interface 450 that enables communication with other devices via communication channel 460. The communication interface 450 can include, but is not limited to, a transceiver configured to transmit and to receive data over communication channel 460. The communication interface 450 can include, but is not limited to, a modem or network card and the communication channel 460 may be implemented, for example, within a wired and/or a wireless medium.

Data is streamed, or otherwise provided, to the system 400, in various examples, using a wireless network such as a Wi-Fi network, for example IEEE 802.11 (IEEE refers to the Institute of Electrical and Electronics Engineers). The Wi-Fi signal of these examples is received over the communications channel 460 and the communications interface 450 which are adapted for Wi-Fi communications. The communications channel 460 of these examples is typically connected to an access point or router that provides access to external networks including the Internet for allowing streaming applications and other over-the-top communications. Other examples provide streamed data to the system 400 using a set-top box that delivers the data over the HDMI connection of the input block 445. Still other examples provide streamed data to the system 400 using the RF connection of the input block 445. As indicated above, various examples provide data in a non-streaming manner. Additionally, various examples use wireless networks other than Wi-Fi, for example a cellular network or a Bluetooth® network.

The system 400 can provide an output signal to various output devices, including a display 475, speakers 485, and other peripheral devices 495. The display 475 of various examples includes one or more of, for example, a touchscreen display, an organic light-emitting diode (OLED) display, a curved display, and/or a foldable display. The display 475 may be for a television, a tablet, a laptop, a cell phone (mobile phone), or other device. The display 475 can also be integrated with other components (for example, as in a smart phone), or separate (for example, an external monitor for a laptop). The other peripheral devices 495 include, in various examples, one or more of a stand-alone digital video disc (or digital versatile disc) (DVD, for both terms), a disk player, a stereo system, and/or a lighting system. Various examples use one or more peripheral devices 495 that provide a function based on the output of the system 400. For example, a disk player performs the function of playing the output of the system 400.

In various examples, control signals are communicated between the system 400 and the display 475, speakers 485, or other peripheral devices 495 using signaling such as AV.Link, Consumer Electronics Control (CEC), or other communications protocols that enable device-to-device control with or without user intervention. The output devices may be communicatively coupled to system 400 via dedicated connections through respective interfaces 470, 480, and 490. Alternatively, the output devices may be connected to system 400 using the communications channel 460 via the communications interface 450. The display 475 and speakers 485 may be integrated in a single unit with the other components of system 400 in an electronic device such as, for example, a television. In various examples, the display interface 470 includes a display driver, such as, for example, a timing controller (T Con) chip.

The display 475 and speakers 485 can alternatively be separate from one or more of the other components, for example, if the RF portion of input 445 is part of a separate set-top box. In various examples in which the display 475 and speakers 485 are external components, the output signal may be provided via dedicated output connections, including, for example, HDMI ports, USB ports, or COMP outputs.

The examples may be carried out by computer software implemented by the processor 410 or by hardware, or by a combination of hardware and software. As a non-limiting example, the examples may be implemented by one or more integrated circuits. The memory 420 may be of any type appropriate to the technical environment and may be implemented using any appropriate data storage technology, such as optical memory devices, magnetic memory devices, semiconductor-based memory devices, fixed memory, and removable memory, as non-limiting examples. The processor 410 may be of any type appropriate to the technical environment, and can encompass one or more of microprocessors, general purpose computers, special purpose computers, and processors based on a multi-core architecture, as non-limiting examples.

Various implementations involve decoding. “Decoding”, as used in this application, can encompass all or part of the processes performed, for example, on a received encoded sequence in order to produce a final output suitable for display. In various examples, such processes include one or more of the processes typically performed by a decoder, for example, entropy decoding, inverse quantization, inverse transformation, and differential decoding. In various examples, such processes also, or alternatively, include processes performed by a decoder of various implementations described in this application, for example, obtain a current coding block; determine whether to temporally predict a partition parameter associated with the current coding block, for example, based on coding information associated with the current coding block; decode the current coding block based on the determining; obtain a collocated picture of a current picture that comprises the current coding block, for example, based on the motion vector difference being less than a value; identify, in the collocated picture, a collocated coding block of the current block; determine the partition parameter associated with the current coding block, for example, based on partition information associated with the collocated coding block; obtain a collocated picture of a current picture that comprises the current coding block, for example, based on the MVD being zero; identify, in the collocated picture, a collocated coding block of the current block; determine the partition parameter associated with the current coding block, for example, based on partition information associated with the collocated coding block; (e.g., determine to) refrain from temporally predicting the partition parameter associated with the current coding block, for example, based on the MVD being above a value; etc.

As further examples, in one example “decoding” refers only to entropy decoding, in another example “decoding” refers only to differential decoding, and in another example “decoding” refers to a combination of entropy decoding and differential decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on an input video sequence in order to produce an encoded bitstream. In various examples, such processes include one or more of the processes typically performed by an encoder, for example, partitioning, differential encoding, transformation, quantization, and entropy encoding. In various examples, such processes also, or alternatively, include processes performed by an encoder of various implementations described in this application, for example, obtain a current coding block; determine whether to temporally predict a partition parameter associated with the current coding block, for example, based on coding information associated with the current coding block; decode the current coding block based on the determining; obtain a collocated picture of a current picture that comprises the current coding block, for example, based on the motion vector difference being less than a value; identify, in the collocated picture, a collocated coding block of the current block; determine the partition parameter associated with the current coding block, for example, based on partition information associated with the collocated coding block; obtain a collocated picture of a current picture that comprises the current coding block, for example, based on the MVD being zero; identify, in the collocated picture, a collocated coding block of the current block; determine the partition parameter associated with the current coding block, for example, based on partition information associated with the collocated coding block; (e.g., determine to) refrain from temporally predicting the partition parameter associated with the current coding block, for example, based on the MVD being above a value; etc.

As further examples, in one example “encoding” refers only to entropy encoding, in another example “encoding” refers only to differential encoding, and in another example “encoding” refers to a combination of differential encoding and entropy encoding. Whether the phrase “encoding process” is intended to refer specifically to a subset of operations or generally to the broader encoding process will be clear based on the context of the specific descriptions and is believed to be well understood by those skilled in the art.

Note that syntax elements as used herein, such as SPLIT_BT_VER, SPLIT_BT_HOR, split_cu_flag, split_qt_flag, mtt_split_cu_vertical_flag, mtt_split_cu_binary_flag, MttSplitMode, MinQTSize, MaxBtSize, MaxTtSize, MaxMttDepth, MinCbSize, ph_temporal_mvp_enabled_flag, ph_collocated_ref_idx, sh_collocated_from_l0_flag, sh_collocated_ref_idx, intra_subpartitions_mode_flag, intra_subpartitions_split_flag, ISP_NO_SPLIT, ISP_HOR_SPLIT, ISP_VER_SPLIT, ΔmaxD_{MTT}, intra_subpartitions_split_flag, cu_sbt_flag, gpm_mode_index, gpm_intra_flag, Num_{gpm_intra} sgpm_flag, Num_{sgpm}, ibc_gpm_flag, Num_{ibc_gpm}, split_mode_set_flag, Num_{splitt_mode_set}, etc. are descriptive terms. As such, they do not preclude the use of other syntax element names.

When a figure is presented as a flow diagram, it should be understood that it also provides a block diagram of a corresponding apparatus. Similarly, when a figure is presented as a block diagram, it should be understood that it also provides a flow diagram of a corresponding method/process.

The implementations and aspects described herein may be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus may be implemented in, for example, appropriate hardware, software, and firmware. The methods may be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one example” or “an example” or “one implementation” or “an implementation”, as well as other variations thereof, means that a particular feature, structure, characteristic, and so forth described in connection with the example is included in at least one example. Thus, the appearances of the phrase “in one example” or “in an example” or “in one implementation” or “in an implementation”, as well any other variations, appearing in various places throughout this application are not necessarily all referring to the same example.

Additionally, this application may refer to “determining” various pieces of information. Determining the information can include one or more of, for example, estimating the information, calculating the information, predicting the information, or retrieving the information from memory. Obtaining may include receiving, retrieving, constructing, generating, and/or determining.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. Encoder signals may include, for example, SBT type and SBT position information, an IPM candidate list and index, an IBC-GPM geometry partitioning mode set flag, an IBC-GPM intra flag, a merge index, a flag signaled for a block to indicate if the direct copy of partitioning parameters is applied or to indicate searching a new coding tree structure, etc. In this way, in an example the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling may be used without transmitting (implicit signaling) to simply allow the decoder to know and select the particular parameter. By avoiding transmission of any actual functions, a bit savings is realized in various examples. It is to be appreciated that signaling may be accomplished in a variety of ways. For example, one or more syntax elements, flags, and so forth are used to signal information to a corresponding decoder in various examples. While the preceding relates to the verb form of the word “signal”, the word “signal” can also be used herein as a noun.

As will be evident to one of ordinary skill in the art, implementations may produce a variety of signals formatted to carry information that may be, for example, stored or transmitted. The information can include, for example, instructions for performing a method, or data produced by one of the described implementations. For example, a signal may be formatted to carry the bitstream of a described example. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on, or accessed or received from, a processor-readable medium.

Many examples are described herein. Features of examples may be provided alone or in any combination, across various claim categories and types. Further, examples may include one or more of the features, devices, or aspects described herein, alone or in any combination, across various claim categories and types. For example, features described herein may be implemented in a bitstream or signal that includes information generated as described herein. The information may allow a decoder to decode a bitstream, the encoder, bitstream, and/or decoder according to any of the embodiments described. For example, features described herein may be implemented by creating and/or transmitting and/or receiving and/or decoding a bitstream or signal. For example, features described herein may be implemented a method, process, apparatus, medium storing instructions, medium storing data, or signal. For example, features described herein may be implemented by a TV, set-top box, cell phone, tablet, or other electronic device that performs decoding. The TV, set-top box, cell phone, tablet, or other electronic device may display (e.g. using a monitor, screen, or other type of display) a resulting image (e.g., an image from residual reconstruction of the video bitstream). The TV, set-top box, cell phone, tablet, or other electronic device may receive a signal including an encoded image and perform decoding.

Block partitioning may be implemented. A coding tree unit (CTU) may be split into coding units (CUs), for example, by using a quaternary-tree structure denoted as coding tree to adapt to various local characteristics. The decision whether to code a picture area using inter-picture (temporal) or intra-picture (spatial) prediction may be made at the leaf CU level. A (e.g., each) leaf CU may be (e.g., further) split into one, two or four prediction units (PUs) according to the PU splitting type. A (e.g., the same) prediction process may be applied inside a PU. The relevant information may be transmitted to the decoder on a PU basis. The residual block may be obtained by applying the prediction process based on the PU splitting type. A leaf CU may be partitioned into transform units (TUs) (e.g., after the residual block is obtained), for example, according to another quaternary-tree structure similar to the coding tree for the CU. A coding structure may have multiple partition conceptions, e.g., including CU, PU, and TU.

A quadtree (QT) with a nested multi-type tree (MTT) using binary and ternary splits segmentation structure may replace the concepts of multiple partition unit types, for example, by removing the separation of the CU, PU and TU concepts, except as needed for CUs that have a size too large for the maximum transform length, and/or may support more flexibility for CU partition shapes. In a coding tree structure, a CU may have a square or rectangular shape. A CTU may (e.g., first) be partitioned by a quaternary tree (a.k.a. quadtree) structure. The quaternary tree leaf nodes may be (e.g., further) partitioned, for example, by a multi-type tree structure.

FIG. 5 illustrates an example of splitting types in a multi-type tree structure. As shown in FIG. 5, in some examples there may be four splitting types in a multi-type tree structure, e.g., vertical binary splitting (SPLIT_BT_VER), a horizontal binary splitting (SPLIT_BT_HOR), a vertical ternary splitting (SPLIT_TT_VER), and a horizontal ternary splitting (SPLIT_TT_HOR). The multi-type tree leaf nodes may be called CUs. The segmentation may be used for prediction and transform processing (e.g., without any further partitioning), for example, unless the CU is too large for the maximum transform length. In most cases, the CU, PU, and TU may have the same block size in a quadtree with a nested multi-type tree coding block structure. The exception may occur, for example, if/when the maximum supported transform length is smaller than the width and/or height of the color component of the CU.

FIG. 6 illustrates an example of a signaling mechanism of partition splitting information in a QT with nested MTT coding tree structure. A CTU may be treated as the root of a quaternary tree. A CTU may be (e.g., first) partitioned by a quaternary tree structure. A (e.g., each) quaternary tree leaf node may be (e.g., further) partitioned by an MTT structure, for example, if/when the quaternary tree leaf node is sufficiently large to allow it. In QT with nested MTT coding tree structure, for each CU node, a first flag (split_cu_flag) may be signaled to indicate whether the node is further partitioned. If the current CU node is a quadtree CU node, a second flag (split_qt_flag) may be signaled to indicate whether it's a QT partitioning or MTT partitioning mode. A third flag (mtt_split_cu_vertical_flag) may be signaled to indicate the splitting direction if/when a node is partitioned with MTT partitioning mode. A fourth flag (mtt_split_cu_binary_flag) may be signaled to indicate whether the split is a binary split (BT) or a ternary split (TT). A multi-type tree splitting mode (MttSplitMode) of a CU may be derived, for example, based on the values of mtt_split_cu_vertical_flag and mtt_split_cu_binary_flag, as shown in Table 1.

TABLE 1
Example of MttSplitMode derivation based on multi-type
tree syntax elements

| | mtt_split_cu_ | mtt_split_cu_ |
|---|---|---|
| MttSplitMode | vertical_flag | binary_flag |
| SPLIT_TT_HOR | 0 | 0 |
| SPLIT_BT_HOR | 0 | 1 |
| SPLIT_TT_VER | 1 | 0 |
| SPLIT_BT_VER | 1 | 1 |

FIG. 7 illustrates an example of a CTU divided into multiple CUs with a quadtree and nested multi-type tree coding block structure. The bold block edges may represent quadtree partitioning. The remaining edges may represent multi-type tree partitioning. The QT with nested MTT partition may provide a content-adaptive coding tree structure comprised of CUs. The size of the CU may be, for example, as large as the CTU or as small as 4×4 in units of luma samples. In some examples (e.g., for a 4:2:0 chroma format), the maximum chroma CB size may be 64×64 and/or the minimum size chroma CB may include 16 chroma samples. In some examples, the maximum supported luma transform size may be 64×64 and/or the maximum supported chroma transform size may be 32×32. A CB may automatically split in the horizontal and/or vertical direction to meet a transform size restriction in the direction, for example, if/when the width or height of the CB is larger than the maximum transform width or height.

Parameters may be defined for the QT with nested MTT coding tree scheme. The parameters may be specified, for example, by sequence parameter set (SPS) syntax elements. The parameters may be (e.g., further) refined, for example, by picture header syntax elements. For example, a CTU size parameter may indicate the root node size of a quaternary tree. A MinQTSize parameter may indicate the minimum allowed quaternary tree leaf node size. A MaxBtSize parameter may indicate the maximum allowed binary tree root node size. A MaxTtSize parameter may indicate the maximum allowed ternary tree root node size. A MaxMttDepth parameter may indicate the maximum allowed hierarchy depth of multi-type tree splitting from a quadtree leaf. A MinCbSize parameter may indicate the minimum allowed coding block node size.

In some examples of a quadtree with nested multi-type tree coding tree structure, a CTU size may be set as 128×128 luma samples with two corresponding 64×64 blocks of 4:2:0 chroma samples, MinQTSize may be equal to 8×8, MaxBtSize may be set as 128×128, MaxTtSize may be set as 64×64, MinCbsize (e.g., for both width and height) may be set as 4×4, and MaxMttDepth may be set as 4. Quaternary tree partitioning may be applied to the CTU first to generate quaternary tree leaf nodes. Quaternary tree leaf nodes may have a size, for example, from 8×8 (e.g., the MinQTSize) to the CTU size. A leaf QT node with a size higher than MaxBtSize and MaxTtSize may not be further split with a binary or ternary split mode. A leaf quadtree node with a size lower than MaxBtSize and MaxTtSize may be further partitioned by the multi-type tree. A quaternary tree leaf node may (e.g., also) be the root node for the multi-type tree. A quaternary tree leaf node may have a multi-type tree depth set as 0. No further splitting may be considered, for example, if/when the multi-type tree depth reaches MaxMttDepth (e.g., for example 4). No further horizontal splitting may be considered, for example, if/when the multi-type tree node has width equal to MinCbsize. No further vertical splitting may be considered, for example, if/when the multi-type tree node has a height equal to MinCbsize.

The coding tree scheme may support the ability for the luma and chroma to have a separate block tree structure. The luma and chroma CTBs in a (e.g., one) CTU may share the same coding tree structure, e.g., for P and B slices. The luma and chroma may have separate block tree structures for I slices. When a separate block tree mode is applied, luma CTB may be partitioned into CUs by one coding tree structure, and the chroma CTBs may be partitioned into chroma CUs by another coding tree structure. A CU in an I slice may include a coding block of the luma component or coding blocks of two chroma components. A CU in a P or B slice may (e.g., always) include coding blocks of (e.g., all) three-color components, unless the video is monochrome.

A temporal prediction method may be implemented for partitioning parameters. A temporal prediction method may be implemented for the partitioning parameters of QT, TT, and BT. The partitioning parameters of QT, TT, and BT may have temporal relationships. The predictions of the partitioning parameters for a (e.g., each) block may (e.g., therefore) be based on temporal parameters, which may be obtained from (e.g., several) temporal blocks in a local neighborhood.

A temporal prediction method may predict the allowance of split partitioning and/or the maximum multi-tree depth for a given block, for example, based on the previous coded frames in a sequence.

Allowance of split partitioning may be determined/predicted for a (e.g., each) block. The allowance of split partitioning may be predicted (e.g., for each block), for example, according to the minimum QT split and/or the average QT split obtained from a temporal area (e.g., collocated CTU or set of collocated CTUs in a collocated picture). The QT split (e.g., only the QT split) may be allowed, for example, if/when the current QT depth is inferior to the temporal minimum QT depth minus 1. No split, QT Split, and TT split may be allowed, and BT split may be allowed if TT is selected in a parent node, for example, if/when the current QT depth is inferior to the temporal average QT depth minus 1.

There may be an adaptive MTT depth parameter. The maximum multi-tree depth may be predicted for a (e.g., each) block. The maximum multi-tree depth may be decreased, for example, if the temporal maximum multi-tree depth is inferior to the maximum multi-tree depth of the current block, unless the current QP is superior or equal to the QP of the reference frame. The maximum multi-tree depth may be incremented, for example, if the temporal maximum multi-tree depth is superior to the maximum multi-tree depth of the current block and if the current depth is equal to the current QT depth.

A collocated picture may be defined, for example, (e.g., only) if/when temporal motion vector prediction (TMVP) is enabled. TMVP may be enabled, for example, if/when ph_temporal_mvp_enabled_flag is equal to 1.

During decoding (e.g., at the beginning of decoding) of a (e.g., each) P or B slice (e.g., after the decoding of the slice header, and after reference picture lists are computed for the current slice), the collocated picture may be determined as the reference picture with an index equal to parsed picture header syntax element ph_collocated_ref_idx, in the reference picture list L0 or L1 identified by picture header syntax element ph_collocated_from_l0_flag. If the two syntax elements ph_collocated_ref_idx and ph_collocated_from_l0_flag are not present in picture header, then slice header syntax elements sh_collocated_from_l0_flag and sh_collocated_ref_idx may be used to identify the collocated picture of the current picture.

An intra sub-partition (ISP) may divide luma intra-predicted blocks vertically or horizontally into two (2) or four (4) sub-partitions, for example, depending on the block size, as shown in Table 2. Sub-partitions (e.g., all sub-partitions) may fulfill the condition of having at least 16 samples. Blocks of size 4×4 may not be divided into sub-partitions. Blocks of size 4×8 and 8×4 may have, for example, (e.g., only) two partitions. Blocks of (e.g., all) other sizes may have, for example, (e.g., only) four sub-partitions. The sub-partitions may be, for example, horizontal or vertical. For example, a block of size 4×8 may have (e.g., only) two vertical partitions of size 4×4 each whereas a block of size 8×4 may have (e.g., only) two horizontal partitions of size 4×4 each. A block of size 4×16 may have, for example, four vertical sub-partitions of size 4×4 each or four horizontal sub-partitions of size 1×16 each.

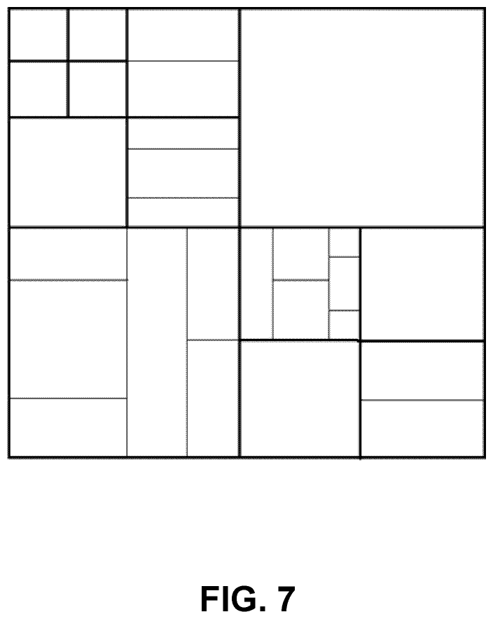

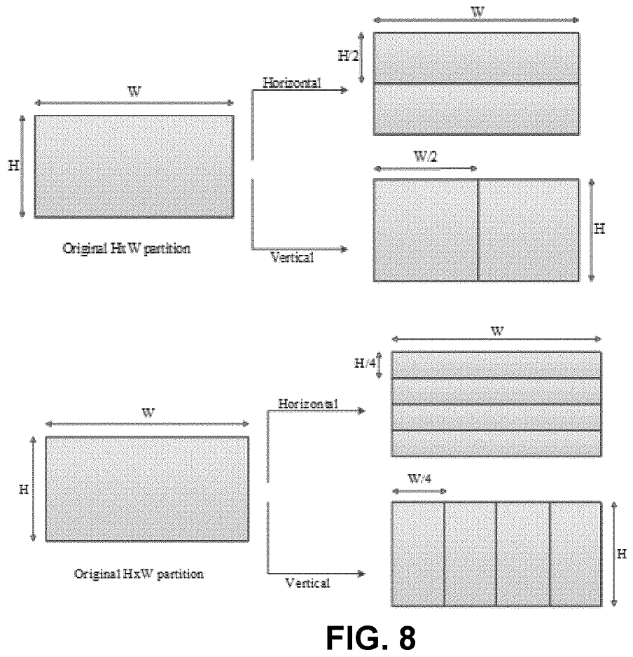

FIG. 8 illustrates examples of intra sub-partitions.

TABLE 2
Example of number of sub-partitions depending
on block size

| | Number of | |
|---|---|---|
| Block Size | Sub-Partitions | Block Size |
| 4 × 4 | 1 | 4 × 4 |
| 4 × 8 and 8 × 4 | 2 | 4 × 8 and 8 x 4 |
| All other cases | 4 | All other cases |

One or more of the following parameters may be defined for specifying how a CU is partitioned to several transform block subpartitions: an intra_subpartitions_mode_flag and/or an intra_subpartitions_split_flag. An intra_subpartitions_mode_flag may specify that the current intra CU is or is not partitioned into two (2) or four (4) transform block subpartitions. An intra_subpartitions_split_flag may specify whether the intra subpartitions split type is horizontal or vertical when intra_subpartitions_mode_flag is equal to 1.

The type of split used for a luma intra-predicted CU may be derived, for example, using bit ‘0’ (ISP_NO_SPLIT) or bits ‘10’ or ‘11’ (ISP_HOR_SPLIT and ISP_VER_SPLIT), as shown by example in Table 3.

TABLE 3
Example of IntraSubPartitionsSplitType derivation
based on ISP syntax elements

| | intra_ | intra_ |
|---|---|---|
| | subpartitions_ | subpartitions_ |
| IntraSubPartitionsSplitType | mode_flag | split_flag |
| ISP_NO_SPLIT | 0 | x |
| ISP_HOR_SPLIT | 1 | 0 |
| ISP_VER_SPLIT | 1 | 1 |

A subblock transform (SBT) may be used for an inter-predicted CU, for example, except an inter-predicted CU coded with combined inter-intra mode. In SBT mode, (e.g., only) a sub-part of the residual block may be coded for the CU. A flag (e.g., cu_sbt_flag) may be signaled to indicate whether the whole residual block or a sub-part of the residual block is coded, for example, if/when inter-predicted CU with cu_coded_flag equal to 1. Inter MTS information may be (e.g., further) parsed (e.g., in the former case) to determine the transform type of the CU. A part of the residual block may be coded with an inferred adaptive transform and the other part of the residual block may be zeroed out (e.g., in the latter case).

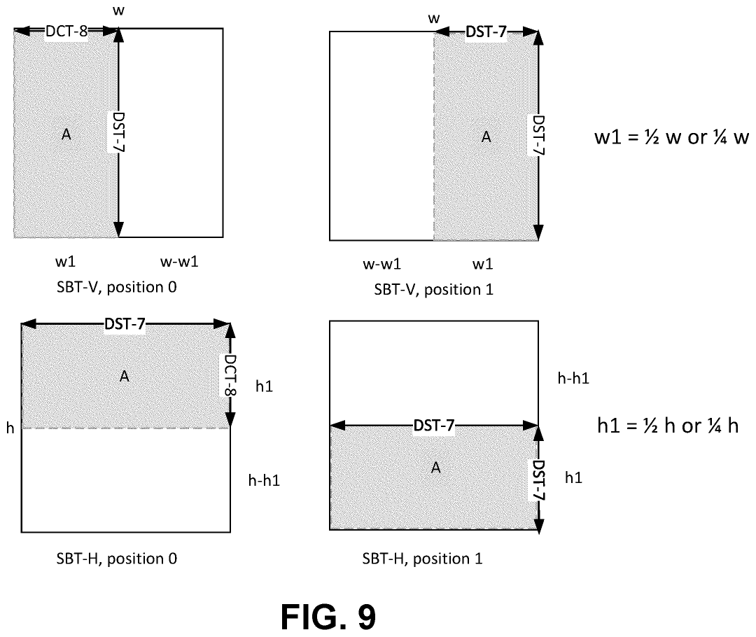

SBT type and/or SBT position information may be signaled in the bitstream, for example, if/when SBT is used for an inter-coded CU. There may be one or more (e.g., two) SBT types and one or more (e.g., two) SBT positions, as indicated by example in FIG. 9.

FIG. 9 illustrates an example of SBT type and position information that may be signaled in a bitstream. As shown in FIG. 9, for SBT-V (or SBT-H), the TU width (or height) may equal to half of the CU width (or height) or ¼ of the CU width (or height), resulting in 2:2 split or 1:3/3:1 split. The 2:2 split may be similar to a binary tree (BT) split while the 1:3/3:1 split may be similar to an asymmetric binary tree (ABT) split. In ABT splitting, (e.g., only) the small region may include the non-zero residual.

In some examples, there may be (e.g., at most) eight (8) SBT modes for a CU. In an example with a dimension of a CU that is four (4) in luma samples, a 2:2 split along the dimension may be disallowed. For example, allowSbtVerH may be true when CU width is superior to 4, and allowSbtHorH may be true when CU height is superior to 4. In an example with a dimension of a CU that is eight (8) in luma samples, the 1:3/3:1 split along that dimension may be disallowed. For example, allowSbtVerQ may be true when CU width is superior to eight (8), and allowSbtHorQ may be true when CU height is superior to eight (8).

A position-dependent transform core selection may be applied on luma transform blocks in SBT-V and SBT-H (e.g., chroma TB (always) using DCT-2). The two positions of SBT-H and SBT-V may be associated with different core transforms. The horizontal and vertical transforms for each SBT position may be specified, for example, as shown in FIG. 9. For example, the horizontal and vertical transforms for SBT-V position 0 may be DCT-8 and DST-7, respectively. The transform for both dimensions may be set as DCT-2, for example, if/when one side of the residual TU is greater than 32. The subblock transform may jointly specify the TU tiling, coded block flag (CBF), and horizontal and vertical core transform type of a residual block.

One or more parameters may be defined for specifying how SBT may be used for an inter-coded CU. For example, parameter cu_sbt_flag may specify whether the current inter-coded CU used or did not use a subblock transform. Parameter cu_sbt_quad_flag may specify whether the subblock transform includes a TU of ¼ size of the current CU (e.g., if/when cu_sbt_quad_flag equals 1) or of ½ size of the current CU. Parameter cu_sbt_horizontal_flag may specify whether the current CU is split into two (2) TUs horizontally (e.g., if/when cu_sbt_horizontal_flag equals 1) or vertically. The value of cu_sbt_horizontal_flag may be derived, for example, if/when cu_sbt_horizontal_flag is not present. The value of cu_sbt_horizontal_flag may be set to be equal to allowSbtHorQ, for example, if/when cu_sbt_quad_flag equals 1. The value of cu_sbt_horizontal_flag may be set equal to allowSbtHorH, for example, if otherwise (e.g., if/when cu_sbt_quad_flag equals 0). The parameter cu_sbt_pos_flag may specify whether the first TU has no residual data (e.g., if/when cu_sbt_pos_flag equals 1) or whether a second TU has no residual data.

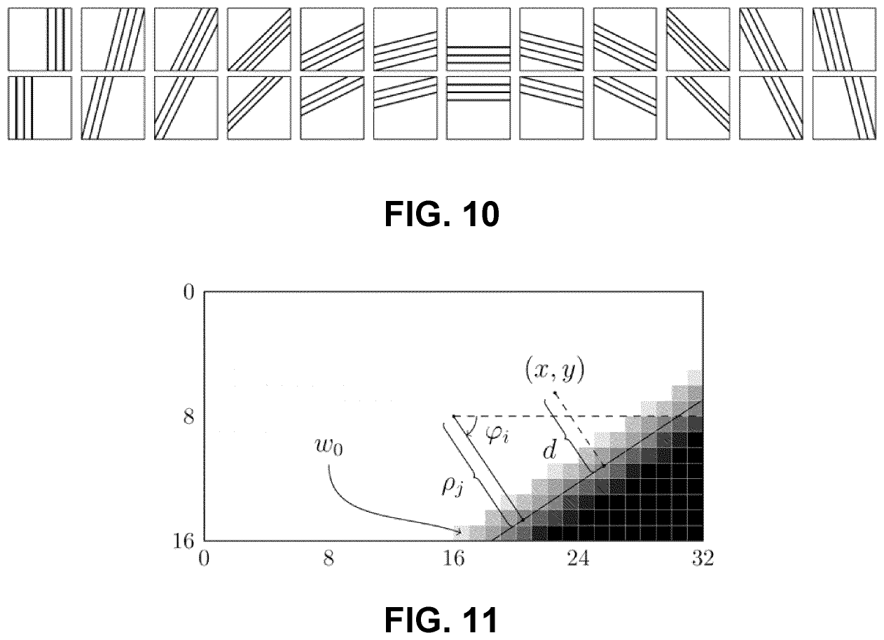

A geometric partition mode (GPM) may also be known as a geometric merge mode (GEO). A GPM may be used, for example, with 64 partitions (e.g., in total) for inter prediction. A CU may be split into (e.g., two) partitions by a geometrically located straight line (e.g., as shown by examples in FIG. 10), for example, if/when GPM is used.

FIG. 10 illustrates an example of splitting a CU in geometric partition mode. As shown in FIG. 10, the location of the splitting line may be mathematically derived from the angle φᵢ and distance offset ρᵢ of a (e.g., specific) partition. A (e.g., each) partition in the CU may be inter-predicted using its own motion parameters. Uni-prediction (e.g., only uni-prediction) may be allowed for a (e.g., each) partition. A (e.g., each) partition may have a (e.g., one) motion vector and a (e.g., one) reference index. The partitions may be predicted. The sample values along the splitting edge may (e.g., then) be adjusted using a blending process with adaptive weights.

The blending weight for a (e.g., each) position of the CU may be derived, for example, based on the distance between individual position and the partition edge. The distance for a position (x,y) to the partition edge may be derived, for example, in accordance with Eq. (1):

d(x,y)=(2×+1−w)cos(φᵢ)+(2y+1−h)sin(φᵢ)−ρᵢ (1)

The weights for a (e.g., each) part of a geometric partition may be derived, for example, in accordance with Eq. (2), Eq. (3), and Eq. (4):

$$wIdxL ( x , y ) = partIdx ? 32 + d ( x , y ) : 32 - d ( x , y ) \qquad ( 2 )$$

$${w}_{0} ( x , y ) = \frac{Clip 3 ( 0 , 8 , ( wIdxL ( x , y ) + 4 ) ≫ 3 )}{8} \qquad ( 3 )$$

$${w}_{1} ( x , y ) = 1 - {w}_{0} ( x , y ) \qquad ( 4 )$$

With reference to Eq. (2), partIdx may depend on the angle index i. An example of weight w₀ is illustrated in FIG. 11.

FIG. 11 illustrates an example of deriving a blending weight for each position of a CU.

GPM Intra refers to Intra modes that may be added to GPM to combine an inter prediction with an intra prediction.

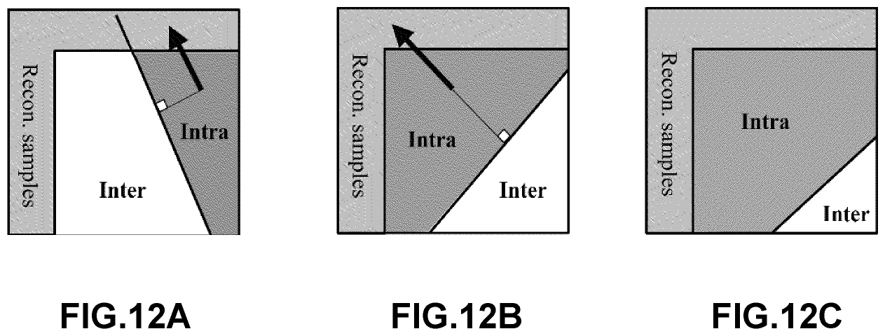

In GPM with inter and intra prediction, the final prediction samples may be generated by weighting inter predicted samples and intra predicted samples for each GPM-separated region. The inter predicted samples may be derived, for example, by the same scheme as the GPM. The intra predicted samples may be derived, for example, by an intra prediction mode (IPM) candidate list and an index signaled from the encoder. The IPM candidate list size may be pre-defined (e.g., as a size of 3). The available IPM candidates may be, for example, the parallel angular mode against the GPM block boundary (Parallel mode), the perpendicular angular mode against the GPM block boundary (Perpendicular mode), and the Planar mode, e.g., as shown by example in FIG. 12.

FIGS. 12A-12C illustrate examples of parallel mode, perpendicular mode, and planar mode IPM candidates that may be added to GPM.

Parallel mode may be registered first, for example, in decoder-side intra mode derivation (DIMD), fusion for template-based intra mode derivation (TIMD), and/or neighboring mode based IPM derivation. A maximum number of (e.g., two) IPM candidates derived from the TIMD, DIMD, and/or the neighboring blocks may be registered, for example, if the same IPM candidate is not in the list. As for the neighboring mode derivation, there may be a maximum number of (e.g., five) positions for available neighboring blocks, but they may be restricted by the angle of GPM block boundary.

Spatial GPM (SGPM) may extend GPM to intra prediction.

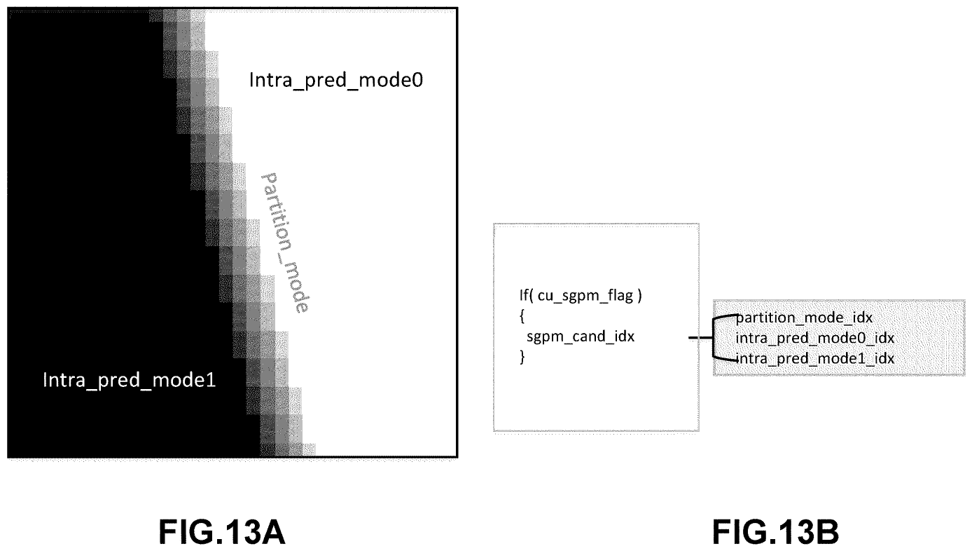

FIGS. 13A and 13B illustrate examples of a partition mode and intra prediction modes for SGPM.

FIG. 13A illustrates an example of a partition mode and intra prediction modes for SGPM. As shown in FIG. 13A, SGPM may include a (e.g., one) partition mode and (e.g., two) associated IPMs. A candidate list may be employed. The candidate index may be signaled in the bit-stream. A (e.g., each) candidate in the list may derive a combination of a (e.g., one) partition mode and (e.g., two) intra prediction modes, as shown in FIG. 13B.

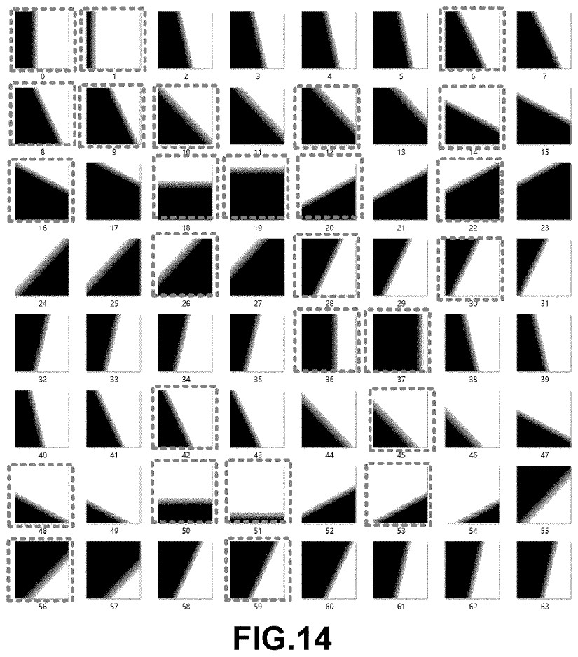

FIG. 13B illustrates an example of deriving a partition mode indicating different intra prediction modes for SGPM. The number of possible partition mode and intra prediction modes may be reduced, for example, to reduce the complexity in building the candidate list. In some examples, (e.g., only) 26 out of 64 partition modes may be used, as shown by example in FIG. 14.

FIG. 14 illustrates an example of partition modes in SGPM. As shown in FIG. 14, the 26 selected partition mode candidates for SGPM are marked by dashed boxes. An IPM candidate list with three (3) entries may be constructed using a similar method as GPM intra.

Intra block copy with geometry partitioning mode (IBC-GPM) is a coding tool, which may be used to divide an IBC-predicted CU into (e.g., two) sub-partitions, geometrically. The prediction signals of the (e.g., two) sub-partitions may be generated, for example, using IBC and intra prediction. An IPM candidate list with (e.g., 3) entries may be constructed, for example, using the same or similar method as GPM intra. There may be multiple (e.g., 48) geometry partitioning modes, which may be divided into (e.g., two) geometry partitioning mode sets, for example, in accordance with Table 4 and Table 5:

TABLE 4
Example of geometry partitioning modes in
a first geometry partitioning mode set

| ibc_gpm_partition_idx | 0 | 1 | 2 | 3 | 4 | 5 | 6 | 7 |
|---|---|---|---|---|---|---|---|---|
| angleIdx | 0 | 0 | 8 | 8 | 16 | 16 | 24 | 24 |
| distanceIdx | 1 | 3 | 1 | 3 | 1 | 3 | 1 | 3 |

TABLE 5
Example of geometry partitioning modes in
the second geometry partitioning mode set

| ibc_gpm_partition_idx | 0 | 1 | 2 | 3 | 4 | 5 | 6 | 7 | 8 | 9 |
|---|---|---|---|---|---|---|---|---|---|---|
| angleIdx | 2 | 2 | 2 | 3 | 3 | 3 | 4 | 4 | 4 | 5 |
| distanceIdx | 0 | 1 | 3 | 0 | 1 | 3 | 0 | 1 | 3 | 0 |
| ibc_gpm_partition_idx | 10 | 11 | 12 | 13 | 14 | 15 | 16 | 17 | 18 | 19 |
| angleIdx | 5 | 5 | 11 | 11 | 11 | 12 | 12 | 12 | 13 | 13 |
| distanceIdx | 1 | 3 | 0 | 1 | 3 | 0 | 1 | 3 | 0 | 1 |
| ibc_gpm_partition_idx | 20 | 21 | 22 | 23 | 24 | 25 | 26 | 27 | 28 | 29 |
| angleIdx | 13 | 14 | 14 | 14 | 18 | 18 | 19 | 19 | 20 | 20 |
| distanceIdx | 3 | 0 | 1 | 3 | 1 | 3 | 1 | 3 | 1 | 3 |
| ibc_gpm_partition_idx | 30 | 31 | 32 | 33 | 34 | 35 | 36 | 37 | 38 | 39 |
| angleIdx | 21 | 21 | 27 | 27 | 28 | 28 | 29 | 29 | 30 | 30 |
| distanceIdx | 1 | 3 | 1 | 3 | 1 | 3 | 1 | 3 | 1 | 3 |

An IBC-GPM geometry partitioning mode set flag may be signaled (e.g., if/when IBC-GPM is used), for example, to indicate whether a first or a second geometry partitioning mode set is selected, e.g., followed by a geometry partitioning mode index. An IBC-GPM intra flag may be signaled to indicate whether intra prediction is used for the first sub-partition. An intra prediction mode index may be signaled, for example, if/when intra prediction is used for a sub-partition. A merge index is signaled, for example, if/when IBC is used for a sub-partition.

Coding tree parameters, such as allowance of split partitioning and/or maximum multi-type tree depth parameter from a temporal area (e.g., collocated CTU or set of collocated CTUs in a collocated picture), may be derived, which may provide coding gains with a decrease in encoding time.

In a slow-moving scene, the prediction between two adjacent frames may look (e.g., very) similar. Therefore, parameters associated with partitioning may be predicted from a previous frame, for example, in a slow-moving scene. Temporal prediction of partitioning parameters between two adjacent frames may not be accurate, for example, when there is fast motion in a scene or scene switching. Coding information of the current block, such as motion vector difference (MVD) of the block, may be used to limit or correct the temporal prediction of the partitioning parameters.

The content between several previous coded frames may be similar. Taking several corresponding temporal areas from several previous coded frames into consideration may (e.g., further) improve the temporal prediction of the partitioning parameters for the blocks in the current frame.

Partitioning parameters of ISP/SBT/GPM may have temporal correlations to be explored from several temporal blocks in previous coded frames.

Temporal prediction of partitioning parameters may be improved, for example, by considering other coding information of the current block and/or more temporal areas from multiple (e.g., several) previously coded frames. Partitioning parameters of ISP/SBT/GPM may be derived with temporal prediction (e.g., in the same spirit) to (e.g., further) improve coding efficiency.

The temporal prediction of partitioning parameters may be improved by utilizing: the coding information (e.g., MVD of the current CU) and/or more temporal areas from (e.g., several) previous coded frames. For example, multiple (e.g., two) collocated reference pictures may be derived and/or used to perform bi-predictive temporal prediction of partitioning parameters for a (e.g., each) B slice. Temporal prediction may be utilized to derive partitioning parameters, such as one or more of the following: the allowance and direction of an ISP split; the allowance, direction and position of an SBT split; and/or the allowances and partitioning modes of GPM Intra/SGPM/IBC-GPM.

Coding information may be utilized to enhance the temporal prediction of partitioning parameters.

Inaccuracy may occur when there is fast motion in a scene or scene switching between two adjacent frames. Using temporal prediction (e.g., alone) to decide the allowance of split partitioning and/or maximum multi-type tree depth parameter of the blocks in the current frame may not result in accuracy. Coding information of the CU, such as motion vector difference (MVD), may be used to limit or correct temporal prediction of partitioning parameters.

The MVD of the current CU may be used to indicate the relative motion of the current CU and its collocated CU(s) in the reference frames. The current CU may (e.g., have a high possibility to) share similar or the same partitioning parameters as collocated CU(s) (e.g., meaning the current CU might not need to be further split), for example, if/when the MVD of the CU is equal to zero (0) or if/when the MVD is inferior to (e.g., less than) a (e.g., pre-defined) threshold.

A method of predicting the allowance of split partitioning and/or the maximum multi-tree depth for a given block can be improved, for example, by allowing split partitioning and/or an adaptive MTT depth parameter.

Allowance of split partitioning may be determined/predicted. No split may be allowed (e.g., only no split may be allowed), for example, if/when the current QT depth is equal to or inferior to the temporal minimum QT depth minus one (1), and if the MVD of the current block equals zero (0). No split may be allowed (e.g., only no split may be allowed), for example, if/when the current QT depth is equal to or inferior to the temporal average QT depth minus one (1).

The MTT depth parameter may be adapted. The maximum multi-tree depth may be decreased or incremented to be equal to the temporal maximum multi-tree depth, for example, if/when the temporal maximum multi-tree depth is unequal to the maximum multi-tree depth of the current block, and if the MVD of the current block is equal to zero (0).

Partitioning parameters for a given block may (e.g., directly) copy partitioning parameters from the collocated CU in the reference frame, for example, if the MVD of the current block equals zero (0). For example, the value(s) of the current QT depth and/or current MTT depth may be copied. An indication (e.g., a flag) may be signaled for a (e.g., each) block, for example, to indicate whether applying a (e.g., direct) copy of partitioning parameters or searching for a new coding tree structure.

The temporal prediction (e.g., only the temporal prediction) of the partitioning parameters for a given block may be considered, for example, if the MVD of the current block is inferior to a (e.g., pre-defined) threshold.

In some examples, coding information may include the QP, block size, and/or color component of the current CU, e.g., as alternatives to/instead of or in addition to using the MVD as coding information.

One or more (e.g., several) previously coded frames may be utilized to enhance the temporal prediction of the partitioning parameters.

A collocated picture may be determined (e.g., for each B slice) as the reference picture with the index equal to parsed picture header syntax element ph_collocated_ref_idx, in the reference picture list L0 or L1 identified by picture header syntax element ph_collocated_from_l0_flag or slice header syntax element sh_collocated_from_l0_flag.

Multiple (e.g., two) collocated pictures may be derived from reference list L0 and L1, for example, on condition that (e.g., both) the reference picture lists L0 and L1 are valid for a (e.g., one) B slice. Flag ph_collocated_from_l0_flag or flag sh_collocated_from_l0_flag may not (e.g., need to) be checked for B slice, for example, if/when getting the collocated picture from the reference list. The (e.g., both) available reference pictures from the list L0 and L1 may be utilized as the collocated pictures for the temporal prediction of the partitioning parameters. For example, D_{QT}_{₀} and D_{QT}_{₁}, respectively, may represent temporal QT depths of the corresponding temporal area in the first collocated picture and in the second collocated picture.

For example, the bi-predictive temporal minimum QT depth minD_{QT}_{_{tmp_bi}} may be derived from the minimum value between D_{QT}_{₀} and D_{QT}_{₁}, the bi-predictive temporal average QT depth avgD_{QT}_{_{tmp_bi}} may be derived from the average value between D_{QT}_{₀} and D_{QT}_{₁}, and the bi-predictive temporal maximum multi-tree depth maxD_{MTTtmp_bi} may be calculated (e.g., using a similar process), for example, in accordance with Eq. (5), Eq. (6), and Eq. (7):

$${minD}_{{QT}_{tmp \_ bi}} = arg min \{ {D}_{{QT}_{0}} , {D}_{{QT}_{1}} \} \qquad ( 5 )$$

$${avgD}_{{QT}_{tmp \_ bi}} = avg \{ {D}_{{QT}_{0}} , {D}_{{QT}_{1}} \} \qquad ( 6 )$$

$${maxD}_{{MTT}_{tmp\_bi}} = arg max \{ {D}_{{MTT}_{0}} , {D}_{{MTT}_{1}} \} \qquad ( 7 )$$

A method predicting the allowance of split partitioning and/or the maximum multi-tree depth for a given block may be improved, for example, according to the bi-predictive temporal minimum QT depth minD_{QT}_{_{tmp_bi}}, the bi-predictive temporal average QT depth avgD_{QT}_{_{tmp_bi}}, and/or the bi-predictive temporal maximum multi-tree depth maxD_{MTT}_{_{tmp_bi}}.

The bi-predictive temporal partitioning parameters may (e.g., alternatively) be derived using the POC distance. For example, distance₀ and distance₁, respectively, may denote the temporal distance between the current frame and its two collocated reference frames. The bi-predictive temporal minimum QT depth minD_{QT}_{_{tmp_bi}} may be equal to the minimum value of D_{QTo}, for example, if/when distance₀ is less than distance₁, and vice versa. Similar logic may be applied for obtaining the bi-predictive temporal maximum multi-tree depth maxD_{MTT}_{_{tmp_bi}}. The bi-predictive temporal average QT depth avgD_{QT}_{_{tmp_bi}} may be derived from a weighted average value between D_{QT}_{₀} and D_{QT}_{₁}. The weight w may be determined by the relative values of distance₀ and distance₁.

The difference between the temporal depths of the corresponding temporal area in the first collocated picture and in the second collocated picture may be (e.g., alternatively) utilized to limit or correct the temporal prediction of the partitioning parameters. For example, ΔD_{QT} may be the relative QT depth difference between D_{QTo} and D_{QT}, while ΔmaxD_{MTT} may be the relative maximum multi-tree depth difference between D_{MTT}_{₀} and D_{MTT}_{₁}, which may be calculated, for example, in accordance with Eq. (8) and Eq. (9):

ΔD_{QT}=|avg{D_{QT}_{₀}}−avg{D_{QT}_{₁}}| (8)

ΔmaxD_{MTT}=|argmax{D_{MTT}_{₀}}−argmax{D_{MTT}_{₁}}| (9)

A temporal prediction of partitioning parameters may be (e.g., quite) reliable and/or optimal for a current block, which may indicate the current CU has a (e.g., high) possibility to share similar or even the same partitioning parameters as the collocated CU(s), for example, if/when a relative depth difference between the two reference collocated frames is (e.g., very) small. Temporal prediction of the allowance of split partitioning for a given block may be considered, for example, (e.g., only) if the relative QT depth difference ΔD_{QT} is inferior to a (e.g., pre-defined) threshold. A temporal prediction of the maximum multi-tree depth for a given block may be considered, for example, (e.g., only) if the relative maximum multi-tree depth difference ΔmaxD_{MTT} is inferior to a (e.g., another pre-defined) threshold.

Multiple (e.g., two) collocated reference pictures may be two alternative previous coded pictures, such as the most recent coded pictures in the coding order, for example, rather than deriving (e.g., two) collocated pictures from reference list L0 and L1 for bi-predictive temporal prediction of the partitioning parameters.

Multiple (e.g., more than two) previous coded pictures may be utilized for multi-predictive temporal prediction of the partitioning parameters, for example, rather than deriving (e.g., two) collocated reference pictures.

Multiple (e.g., two) collocated blocks may be derived and utilized for a bi-predictive temporal prediction of the partitioning parameters for a (e.g., each) bi-predictive block, for example, rather than deriving (e.g., two) collocated pictures for each B slice.

Temporal prediction may be utilized to derive ISP/SBT/GPM partitioning parameters.

ISP partitioning parameters may be temporally predicted. For example, temporal prediction may be used to derive the partitioning parameters for ISP from (e.g., several) temporal blocks in a local neighborhood in non-I slice (e.g., P slice or B slice).

For a luma intra-predicted block, a collocated block may be found at the same position in the collocated reference frame. An area with a (e.g., pre-defined) size including the collocated block in the collocated reference frame may be defined as its temporal area, such as a CTU including the collocated block is its collocated CTU. The numbers of the (e.g., three) ISP split types counted in the collocated CTU may be used for temporal prediction for ISP partitioning parameters. The temporal number of ISP split type ISP_NO_SPLIT used for luma intra-predicted blocks Num_{ISP_NO_SPLIT} may be counted in the collocated CTU. The temporal numbers of ISP split types ISP_HOR_SPLIT and/or ISP_VER_SPLIT may be counted, respectively, for Num_{ISP_HOR_SPLIT} and Num_{ISP_VER_SPLIT}. In some examples, (e.g., only) the luma intra-predicted blocks with (e.g., 4) sub-partitions may be counted for Num_{ISP_HOR_SPLIT} and Num_{ISP_VER_SPLIT}.

The predictions of the ISP partitioning parameters (e.g., intra_subpartitions_mode_flag and intra_subpartitions_split_flag) for a luma intra-predicted block may be based on obtained temporal parameters inside the collocated CTU.

For example, allowance of ISP split may be determined for each luma intra-predicted block. The allowance of ISP split may be predicted (e.g., for each luma intra-predicted block), for example, according to the temporal number of ISP_NO_SPLIT Num_{ISP_NO_SPLIT} obtained from a temporal area. The ISP_NO_SPLIT (e.g., only the ISP_NO_SPLIT) may be allowed, e.g., meaning that intra_subpartitions_mode_flag may be inferred to be equal to zero (0) for the current luma intra-predicted block, for example, if/when Num_{ISP_NO_SPLIT} is inferior to a (e.g., pre-defined) threshold.

Direction of ISP split may be determined/predicted, for example, if/when intra_subpartitions_mode_flag is equal to 1 for a given luma intra-predicted block with more than a threshold number of pixels (e.g., 32 pixels). The ISP_HOR_SPLIT (e.g., only the ISP_HOR_SPLIT) may be allowed, e.g., meaning that intra_subpartitions_split_flag may be inferred to be equal to zero (0) for the current luma intra-predicted block, for example, if the temporal number of ISP_HOR_SPLIT is superior to the temporal number of ISP_VER_SPLIT and if the temporal number of ISP_HOR_SPLIT is superior to a (e.g., pre-defined) threshold (e.g., Num_{ISP_HOR_SPLIT}>Num_{ISP_VER_SPLIT} && Num_{ISP_HOR_SPLIT}>TH_{ISP_HOR_SPLIT}).

SBT partitioning parameters may be temporally predicted. For example, temporal prediction may be utilized to derive the partitioning parameters for SBT from (e.g., several) temporal blocks in a local neighborhood.

For an inter-predicted block, the numbers of the (e.g., four) SBT syntax elements counted in the collocated temporal area may be used for temporal prediction for SBT partitioning parameters (e.g., similar, as described herein, for ISP). For example, the temporal numbers of cu_sbt_flag, cu_sbt_quad_flag, cu_sbt_horizontal_flag, and/or cu_sbt_pos_flag equal to 1 for inter-predicted blocks may be counted in the collocated temporal area.

The predictions of the SBT partitioning parameters for a given inter-predicted block may be based on obtained temporal parameters inside the collocated temporal area.

For example, allowance of SBT split may be determined/predicted for a (e.g., each) inter-predicted block. The allowance of SBT split may be predicted (e.g., for each inter-predicted block), for example, according to the temporal numbers of cu_sbt_flag Num_{SBT_SPLIT} and of cu_sbt_quad_flag Num_{SBT_QUAD_SPLIT} obtained from a temporal area. SBT may be allowed for the current inter-predicted block, for example, (e.g., only) if/when the Num_{SBT_SPLIT} is superior to a (e.g., pre-defined) threshold. A 2:2 split (e.g., only a 2:2 split) may be allowed, or allowSbtHorQ and/or allowSbtVerQ may be set to zero (0), for example, if/when the Num_{SBT_QUAD_SPLIT} is inferior to a (e.g., another pre-defined) threshold.

The direction of SBT split may be determined/predicted, for example, if/when cu_sbt_flag is equal to one (1) for a given inter-predicted block. The horizontal split (e.g., only the horizontal split) may be allowed, or allowSbtVerH and/or allowSbtVerQ may be set to zero (0), for example, if the temporal number of cu_sbt_horizontal_flag Num_{SBT_HOR_SPLIT} is superior to a (e.g., pre-defined) threshold.

The position of SBT split may be determined/predicted, for example, if/when cu_sbt_flag is equal to one (1) for a given inter-predicted block. The second TU may be forced to zero out (e.g., meaning that cu_sbt_pos_flag may be inferred to be equal to zero (0) for the current inter-predicted block), for example, if the temporal number of cu_sbt_pos_flag Num_{SBT_POS} is inferior to a (e.g., pre-defined) threshold.

GPM and/or extended GPM partitioning parameters may be temporally predicted. For example, a temporal prediction may be utilized to derive the partitioning parameters for GPM or extended GPM from (e.g., several) temporal blocks in a local neighborhood.

For an inter-predicted block using GPM, the temporal number of gpm_intra_flag and/or the temporal statistic of gpm_mode_index for inter-predicted blocks using GPM may be counted in the collocated temporal area. The temporal number of gpm_intra_flag and/or the temporal statistic of gpm_mode_index for inter-predicted blocks using GPM may be used for the temporal prediction for GPM partitioning parameters.

The predictions of the GPM partitioning parameters for a given inter-predicted block using GPM may be based on temporal parameters obtained inside or based on the collocated temporal area.

For example, allowance of GPM Intra may be determined/predicted for a (e.g., each) inter-predicted block using GPM. The allowance of GPM Intra may be predicted, for example, according to the temporal numbers of gpm_intra_flag Num_{gpm_intra} obtained from a temporal area. GPM Intra may be allowed for the current inter-predicted block, for example, (e.g., only) if/when the Num_{gpm_intra} is superior to a (e.g., pre-defined) threshold.

Allowances of GPM partitioning modes may be determined/predicted for an (e.g., each) inter-predicted block using GPM. The allowances of GPM partitioning modes may be predicted, for example, according to a (e.g., each) temporal statistic of a (e.g., each) gpm_mode_index obtained from a temporal area. For each GPM partitioning mode, a gpm_mode_index may be allowed as a candidate for the current inter-predicted GPM block, for example (e.g., only) if/when a temporal statistic for the gpm_mode_index is superior to a (e.g., pre-defined) threshold.

In an example (e.g., for an intra-predicted block), the temporal number of sgpm_flag and/or the temporal statistics of a (e.g., each) partitioning mode from the related candidate index may be counted in the collocated temporal area. Predictions of the SGPM partitioning parameters for a given intra-predicted block may be based on obtained temporal parameters.

For example, allowance of SGPM may be determined/predicted for an (e.g., each) intra-predicted block. The allowance of SGPM may be predicted, for example, according to the temporal numbers of sgpm_flag Num_{sgpm} that may be obtained from a temporal area. SGPM may be allowed for the current intra-predicted block, for example, (e.g., only) if/when the Num_{sgpm} is superior to a (e.g., pre-defined) threshold.

Allowances of SGPM partitioning modes may be determined/predicted for a (e.g., each) intra-predicted block using SGPM. The allowances of SGPM partitioning modes may be predicted, for example, according to the temporal statistics of a (e.g., each) partitioning mode obtained from its related candidate index in a temporal area.

In some examples for an IBC-predicted block, the temporal numbers of ibc_gpm_flag, split_mode_set_flag, split_mode_set_index0, and/or split_mode_set_index1 for IBC-predicted blocks may be counted in the collocated temporal area. The temporal numbers may be used for the temporal prediction for IBC-GPM partitioning parameters.

For example, allowance of IBC-GPM may be determined/predicted for an (e.g., each) IBC-predicted block. The allowance of IBC-GPM may be predicted, for example, according to the temporal number of ibc_gpm_flag Num_{ibc_gpm} obtained from a temporal area. IBC-GPM may be allowed for the current IBC-predicted block, for example, (e.g., only) if/when the Num_{ibc_gpm} is superior to a (e.g., pre-defined) threshold.

Allowance of IBC-GPM geometry partitioning mode set may be determined/predicted for a (e.g., each) IBC-predicted block using IBC-GPM. The allowance of an IBC-GPM geometry partitioning mode set may be predicted, for example, according to the temporal number of split_mode_set_flag Num_{split_mode_set} equal to one (1) obtained from a temporal area. The first geometry partitioning mode set (e.g., only the first geometry partitioning mode set) may be allowed for the current IBC-GPM block, for example, if/when the Num_{split_mode_set} is superior to a (e.g., pre-defined) threshold.

Allowances of IBC-GPM partitioning modes may be determined/predicted for an (e.g., each) IBC-predicted block using IBC-GPM. The allowances of IBC-GPM geometry partitioning modes may be predicted, for example, according to a (e.g., each) temporal statistic of a (e.g., each) split_mode_set_index0 or split_mode_set_index1 obtained from a temporal area. For each IBC-GPM partitioning mode, split_mode_set_index0 or split_mode_set_index1 may be allowed as a candidate for the current IBC-GPM block, for example, (e.g., only) if/when a temporal statistic for split_mode_set_index0 or split_mode_set_index1 is superior to a (e.g., pre-defined) threshold.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1.-20. (canceled)

21. A device for video decoding comprising:
a processor configured to:
obtain a plurality of collocated pictures of a current picture, the current picture comprising a current video block;
identify, for the current video block, a plurality of collocated coding blocks in the plurality of collocated pictures;
predict a partition parameter associated with the current video block based on partition information associated with the plurality of collocated coding blocks; and
decode the current video block based on the predicted partition parameter.

22. The device of claim 21, wherein the plurality of collocated pictures are obtained based on the current picture being a bi-predicted picture.

23. The device of claim 21, wherein the partition information comprises a temporal depth associated with a first collocated coding block and a temporal depth associated with a second collocated coding block in the plurality of collocated coding blocks, and wherein the processor is further configured to:
determine a difference between the temporal depth associated with the first collocated coding block and the temporal depth associated with the second collocated coding block;
compare the difference between the temporal depth associated with the first collocated coding block and the temporal depth associated with the second collocated coding block to a threshold; and
based on the comparison, determine whether to refrain from predicting the partition parameter, wherein prediction of the partition parameter associated with the current video block is performed further based on the difference being below the threshold.

24. The device of claim 21, wherein the processor is further configured to:
obtain a motion vector difference for the current video block;
compare the motion vector difference to a threshold; and
based on the comparison, determine whether to refrain from predicting the partition parameter, wherein prediction of the partition parameter associated with the current video block is performed further based on the motion vector difference being below the threshold.

25. The device of claim 21, wherein the processor is further configured to:
obtain a motion vector difference for the current video block, wherein prediction of the partition parameter associated with the current video block is performed further based on the partition information associated with the plurality of collocated coding blocks and the motion vector difference for the current video block.

26. The device of claim 21, wherein prediction of the partition parameter associated with the current video block is performed further based on at least one of a block partition, an intra sub-partition, a subblock transform, or a geometric partition mode.

27. The device of claim 21, wherein prediction of the partition parameter associated with the current video block is performed further based on the partition information associated with the plurality of collocated coding blocks and at least one of a quantization parameter, a block size, or a color component of the current video block.

28. A method for video decoding comprising:
obtaining a plurality of collocated pictures of a current picture, the current picture comprising a current video block;
identifying, for the current video block, a plurality of collocated coding blocks in the plurality of collocated pictures;
predicting a partition parameter associated with the current video block based on partition information associated with the plurality of collocated coding blocks; and
decoding the current video block based on the predicted partition parameter.

29. The method of claim 28, wherein the plurality of collocated pictures are obtained based on the current picture being a bi-predicted picture.

30. The method of claim 28, wherein the plurality of collocated pictures includes at least one reference picture of the current picture.

31. The method of claim 28, wherein the partition information comprises a temporal depth associated with a first collocated coding block and a temporal depth associated with a second collocated coding block in the plurality of collocated coding blocks, and wherein the method further comprises:
determining a difference between the temporal depth associated with the first collocated coding block and the temporal depth associated with the second collocated coding block;
comparing the difference between the temporal depth associated with the first collocated coding block and the temporal depth associated with the second collocated coding block to a threshold; and
based on the comparison, determining whether to refrain from predicting the partition parameter, wherein prediction of the partition parameter associated with the current video block is performed further based on the difference being below the threshold.

32. The method of claim 28, wherein the method further comprises:
obtaining a motion vector difference for the current video block;
comparing the motion vector difference to a threshold; and
based on the comparison, determining whether to refrain from predicting the partition parameter, wherein prediction of the partition parameter associated with the current video block is performed further based on the motion vector difference being below the threshold.

33. The method of claim 28, wherein the method further comprises:
obtaining a motion vector difference for the current video block, wherein prediction of the partition parameter associated with the current video block is performed further based on the partition information associated with the plurality of collocated coding blocks and the motion vector difference for the current video block.

34. The method of claim 28, wherein prediction of the partition parameter associated with the current video block is performed further based on at least one of a block partition, an intra sub-partition, a subblock transform, or a geometric partition mode.

35. The method of claim 28, wherein prediction of the partition parameter associated with the current video block is performed further based on the partition information associated with the plurality of collocated coding blocks and at least one of a quantization parameter, a block size, or a color component of the current video block.

36. A device for video encoding comprising:
a processor configured to:
obtain a plurality of collocated pictures of a current picture, the current picture comprising a current video block;
identify, for the current video block, a plurality of collocated coding blocks in the plurality of collocated pictures;
predict a partition parameter associated with the current video block based on partition information associated with the plurality of collocated coding blocks; and
encode the current video block based on the predicted partition parameter.

37. The device of claim 36, wherein the plurality of collocated pictures are obtained based on the current picture being a bi-predicted picture.

38. The device of claim 36, wherein the plurality of collocated pictures includes at least one reference picture of the current picture.

39. The device of claim 36, wherein the partition information comprises a temporal depth associated with a first collocated coding block and a temporal depth associated with a second collocated coding block in the plurality of collocated coding blocks, and wherein the processor is further configured to:
determine a difference between the temporal depth associated with the first collocated coding block and the temporal depth associated with the second collocated coding block;
compare the difference between the temporal depth associated with the first collocated coding block and the temporal depth associated with the second collocated coding block to a threshold; and
based on the comparison, determine whether to refrain from predicting the partition parameter, wherein prediction of the partition parameter associated with the current video block is performed further based on the difference being below the threshold.

40. The device of claim 36, wherein the processor is further configured to:
obtain a motion vector difference for the current video block;
compare the motion vector difference to a threshold; and
based on the comparison, determine whether to refrain from predicting the partition parameter, wherein prediction of the partition parameter associated with the current video block is performed further based on the motion vector difference being below the threshold.
